(19) United States
(12) Patent Application Publication
(10) Pub. No.: US 2009/0034261 A1
(43) Pub. Date: Feb. 5, 2009

(54) LED LIGHT FIXTURE

(76) Inventor: Douglas Grove, Tupelo, MS (US)

Correspondence Address: W. EDWARD RAMAGE, COMMERCE CENTER SUITE 1000, 211 COMMERCE ST, NASHVILLE, TN, 37201, US

(21) Appl. No.: 12/185,005

(22) Filed: Aug. 1, 2008

Related U.S. Application Data
(60) Provisional application No. 60/953,459, filed on Aug. 1, 2007.

(51) Int. Cl. F21V 29/00

(52) U.S. Cl. 362/294

(57) ABSTRACT

An LED light fixture with enhanced thermal management. The fixture may be in a surface-mounted or a recessed configuration. The LED is attached with thermally-conductive material, such as thermal transfer tape, to a heat sink or housing. The heat sink may comprise a number of cooling fins to radiate heat, as well as a number of openings to promote cooling air flow. A variety of reflector assemblies can be used for different optical and aesthetic configurations. One or more lenses may be used.

This application claims priority to Provisional Patent Application No. 60/953,459, filed Aug. 1, 2007, by Douglas Grove, entitled “LED Light Fixture,” and is entitled in whole or in part to that filing date for priority. The disclosure, specification, drawings and accompanying documents of Provisional Patent Application No. 60/953,459 are incorporated herein in their entireties by reference.

### FIELD OF INVENTION

This invention relates to a LED light fixture. More particularly, this invention relates to an LED light fixture with improved thermal management and modular optics.

### BACKGROUND OF THE INVENTION

Current light fixtures known in the art have numerous problems with heat. Fixtures are commonly made of plastic, and degrade quickly due to the intense heat from the light source, and will burn anything touched. LEDs are being used as light sources, but LEDs are very sensitive to heat, and overheating reduces the emitted light and life of the LED exponentially. Most current light fixtures also comprise a significant number of parts, including power supply modules that are outside the body of the fixture, and thus are expensive to manufacture and assemble.

Accordingly, what is needed is an LED light fixture with enhanced thermal management to control overheating, and with a limited number of parts to reduce costs and make assembly efficient and easy.

### SUMMARY OF THE INVENTION

The present invention comprises an LED light fixture with enhanced thermal management. The fixture may be in a surface-mounted or a recessed configuration. The LED is attached with thermally-conductive material, such as thermal transfer tape, to a heat sink or housing. The heat sink may comprise a number of cooling fins to radiate heat, as well as a number of openings to promote cooling air flow. A variety of reflector assemblies can be used for different optical and aesthetic configurations.

In one recessed configuration, the housing is box-shaped, with the LED attached via thermal transfer tape to the interior of the housing. The power supply/electronics module is mounted inside the housing. A bottom is removably attached to the housing. A circular opening in the bottom receives a reflector assembly, which extends up to the LED.

### BRIEF DESCRIPTION OF THE DRAWINGS

FIG. 1 shows a perspective view of a light fixture in accordance with one embodiment of the present invention.

FIG. 2 shows another perspective view of the light fixture of FIG. 1.

FIG. 3 shows a top view of the light fixture of FIG. 1.

FIG. 4 shows a bottom view of the light fixture of FIG. 1.

FIG. 5 shows a perspective view of a light fixture in accordance with another embodiment of the present invention.

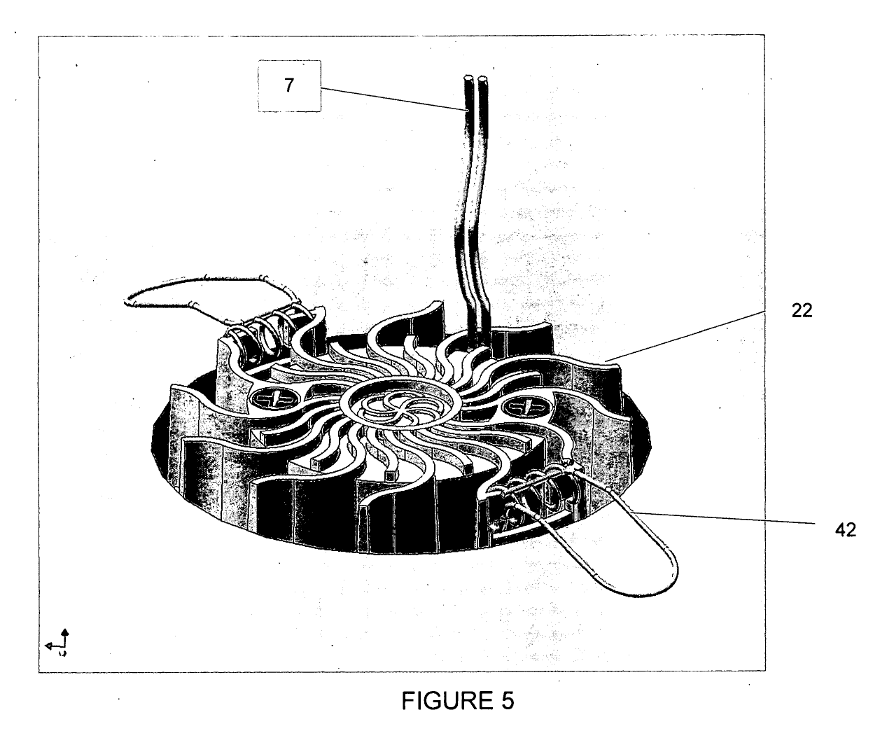

FIG. 6 shows a perspective view of a light fixture in accordance with another embodiment of the present invention.

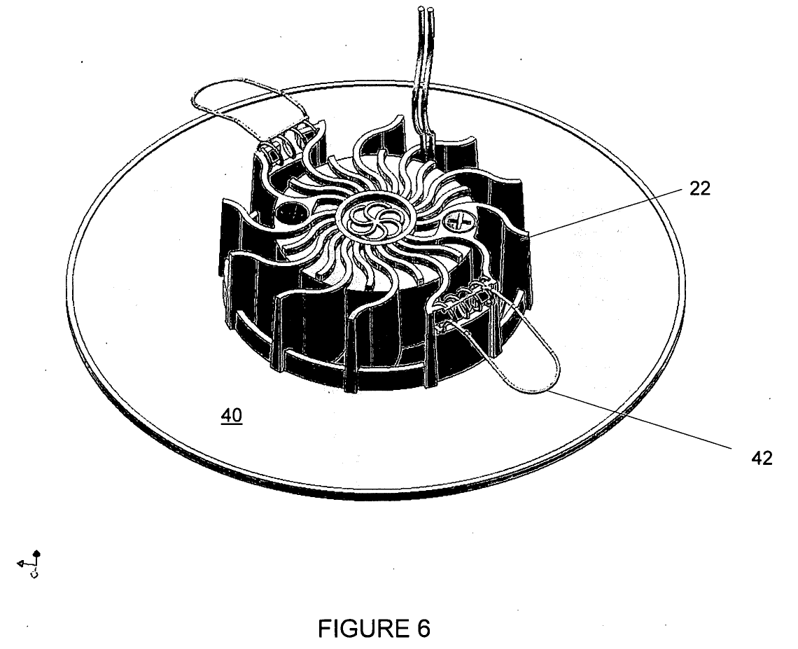

FIG. 7 shows an exploded view of a light fixture in accordance with another embodiment of the present invention.

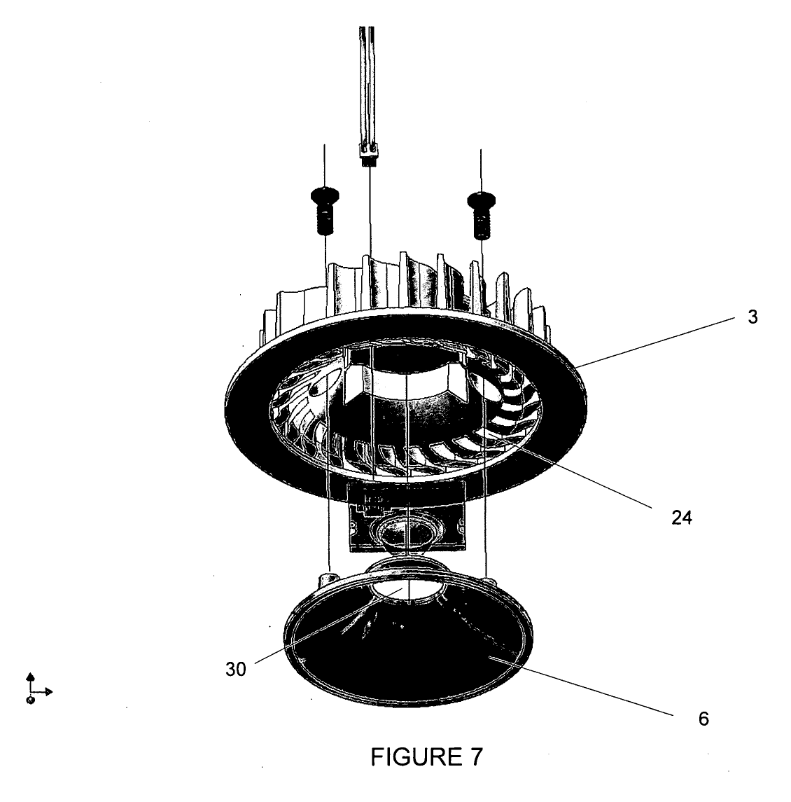

FIG. 8 shows an exploded view of a surface-mounted light fixture in accordance with another embodiment of the present invention.

FIG. 9 shows an exploded view of a recessed light fixture in accordance with another embodiment of the present invention.

FIG. 10 shows a side view of a light fixture with a integral mounting ring in accordance with another exemplary embodiment of the present invention.

FIG. 11 shows an exploded view of another recessed light fixture in accordance with another embodiment of the present invention.

FIG. 12 shows two views of the assembled light fixture of FIG. 11.

FIG. 13 shows a top, side, and bottom view of the assembled light fixture of FIG. 11.

### DETAILED DESCRIPTION OF THE INVENTION

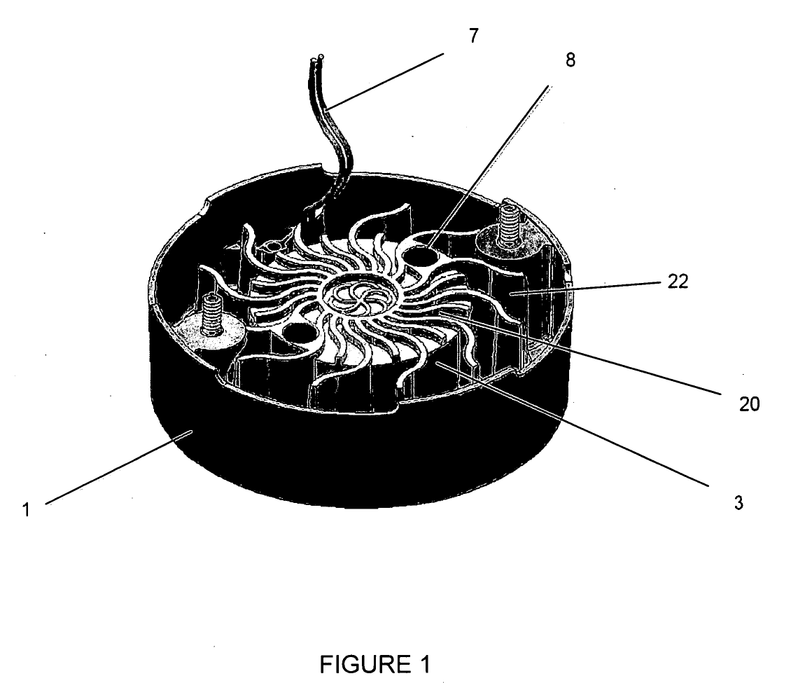

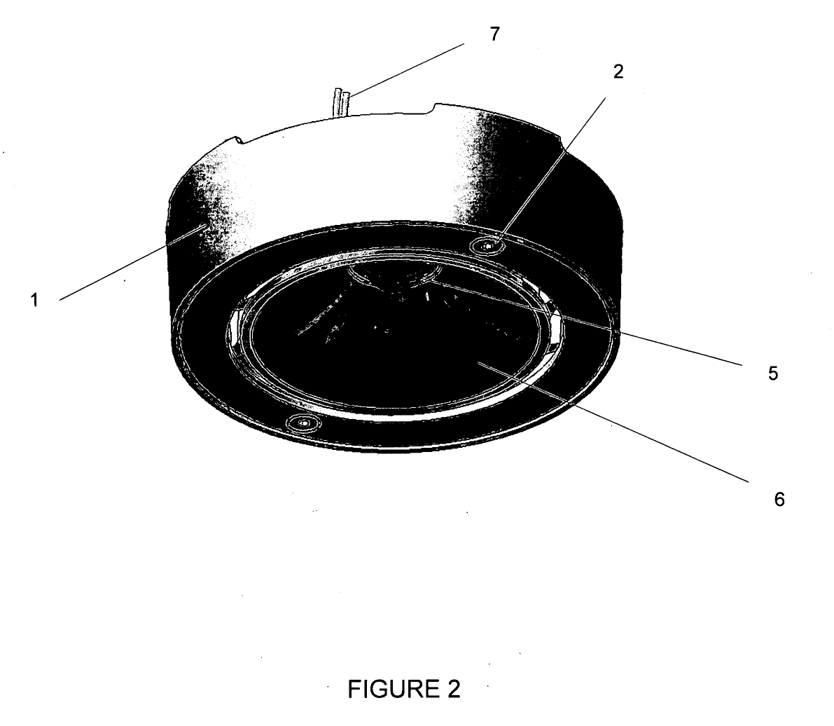

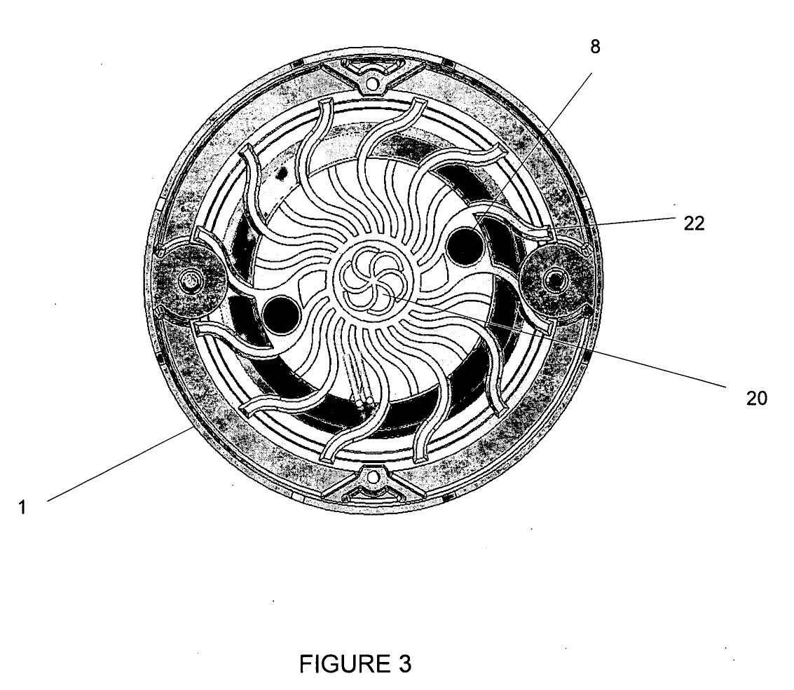

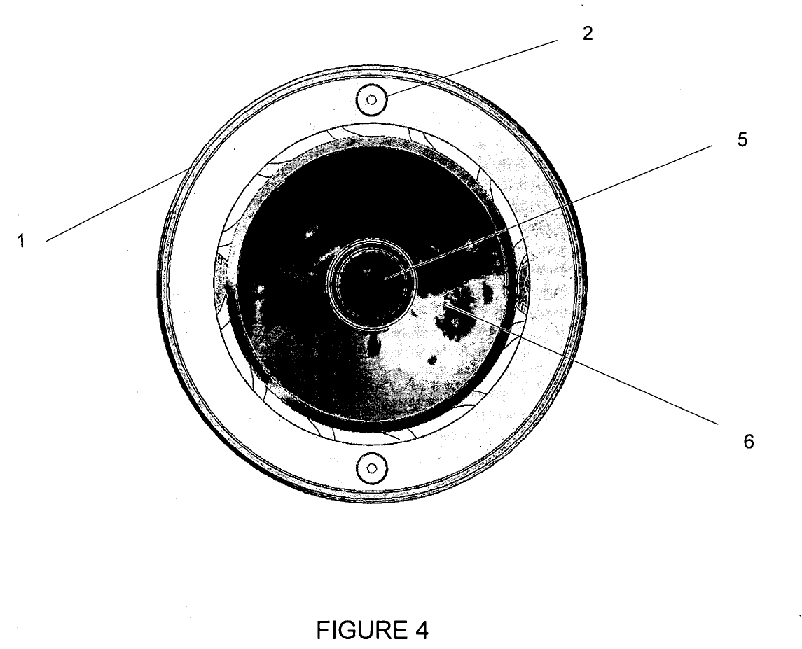

The present invention is an LED lighting fixture. FIGS. 1 through 4 show an exemplary embodiment of the present invention as a surface-mounted fixture. The fixture comprises a mounting ring 1, which while shown as a cylinder in FIG. 1, may be of any suitable shape or configuration. The top of the mounting ring may be closed, partially enclosed, or open (as shown in FIG. 1). Configurations with an open (or partially open) top help with heat management by allowing heat generated by the LED 5 to escape and/or air to circulate. Vents may be located in the mounting ring to promote air flow inside the fixture.

A heat sink element 3 is disposed inside, in whole or in part, the mounting ring 1. The heat sink 3 may be removably affixed to the mounting ring 1 by any of numerous means known in the art, including, but not limited to, clips, bolts or screws 8, as shown in FIG. 1.

The heat sink 3 may be of any suitable design or configuration. In one exemplary embodiment, as shown in FIG. 1, the heat sink may comprise a center 20 with a plurality of cooling fins or vertical structural elements 22 radiating from the center 20. As shown in FIG. 1, the cooling fins 22 may be curved in a variety of configurations, although they also may be straight. Curved fins allow maximum surface area with a minimal number of fins, and with greater air flow. A greater number of straighter fins would be required for the same surface area, but would restrict air flow. Embodiments with curved fins thus allow for more shallow profile luminaries.

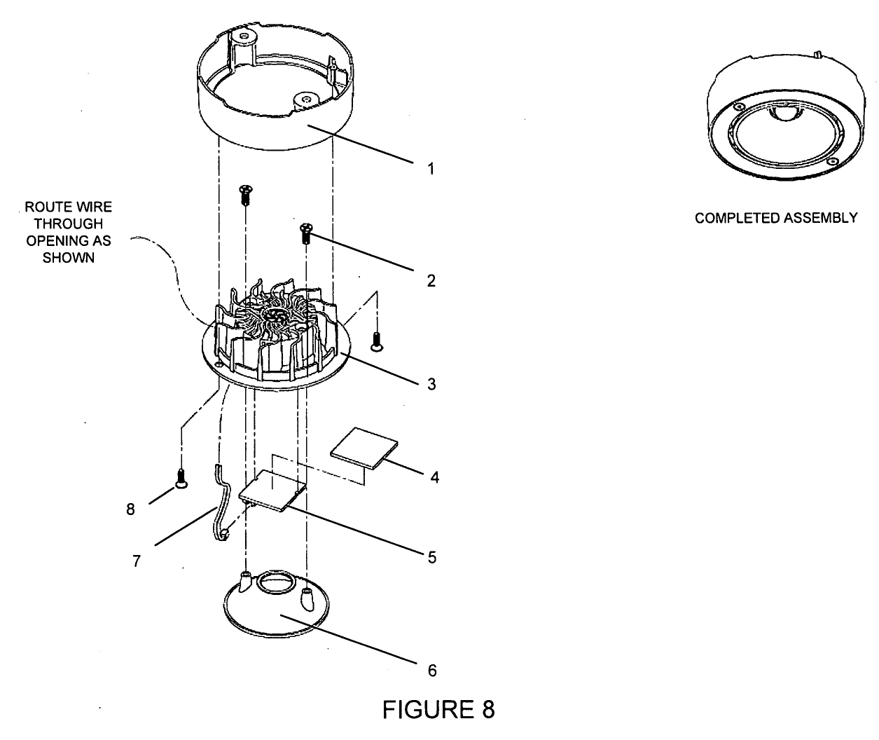

As shown in FIG. 8, a plurality of corresponding openings 24 (i.e., the openings lead to the spaces between the fins) in the heat sink 3 promote the flow of air in the fixture and heat loss, leading to cooler operating temperatures. Curving the cooling fins 22 achieves a balance between air flow and additional surface area of the fins (which increases heat transfer). In addition, a cooling slot at the face may be used to promote air flow up through the fins. The heat sink may comprise multiple parts, or may be constructed in a single piece as shown, which reduces the number of interface points and increases the efficiency of heat transfer.

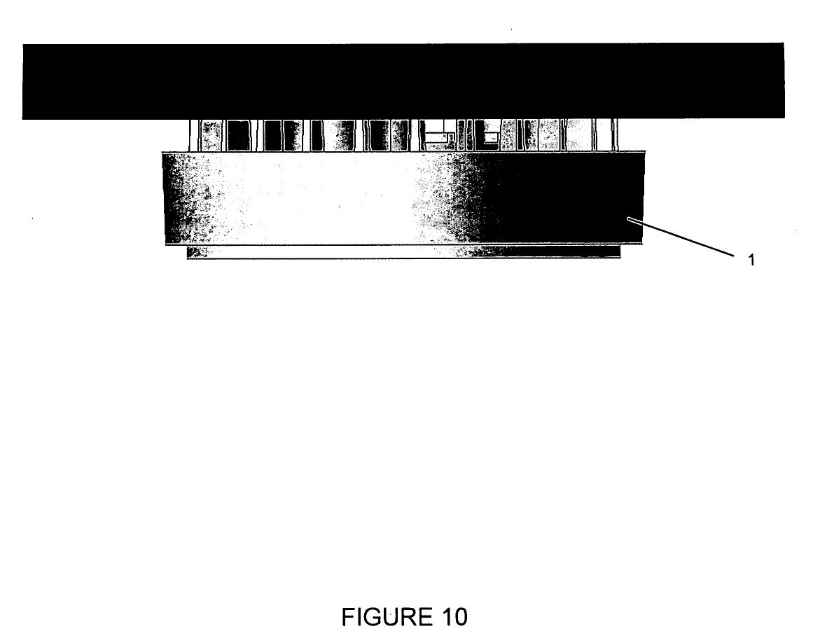

As seen in FIG. 10, the heat sink 3 may be integral with the mounting ring 1. A circular shroud may be added to increase the surface area.

Thus, the design transfers heat away from the LED out through the cooling fins 22. In the recessed configuration, which is likely to have a higher ambient temperature in the recessed cavity, heat may then be transferred down to the lower flange 40, which is exposed to the ambient temperatures in the room.

The light source in the fixture is an LED or LED board 5, which is disposed on the underside of the heat sink 3. The LED 5 may be, but need not be, located in the center of the heat sink 3. The LED 5 may be affixed by a variety of means known in the art, including but not limited to thermal tape 4. An advantage to using thermally conductive tape is that it improves thermal transfer from the LED to the heat sink. The LED 5 may be permanently or removably affixed. Power is provided through an electrical connector 7.

A reflector 6 is fastened to the underside of the fixture. In one exemplary embodiment, the reflector 6 is removable, so that reflectors with different curves and reflective characteristics can be changed. Fastening means include, but are not limited to, bolts, clips, snaps, or screws 2. A hole 30 (or multiple holes) in the reflector permits light from the LED to pass through. This arrangement allows the light to be controlled with reflectors rather than a lens.

In one exemplary embodiment, a reflector mounting screw may be used to align the reflector into an optimal focal point with the LED. In one configuration, the reflector has a high reflectance white concave surface, which provides direct cut off of the LED, provides a uniform reflective surface, and diffuses and softens the light to a wide, uniform beam. In addition to optical control, the reflector also may transfer heat out to the area being illuminated, maximizing the surface area exposed to cooler ambient temperatures. Optical devices, such as, but not limited to, lens, scoops, or baffles, may be used to manipulate the beam to create various distribution patterns.

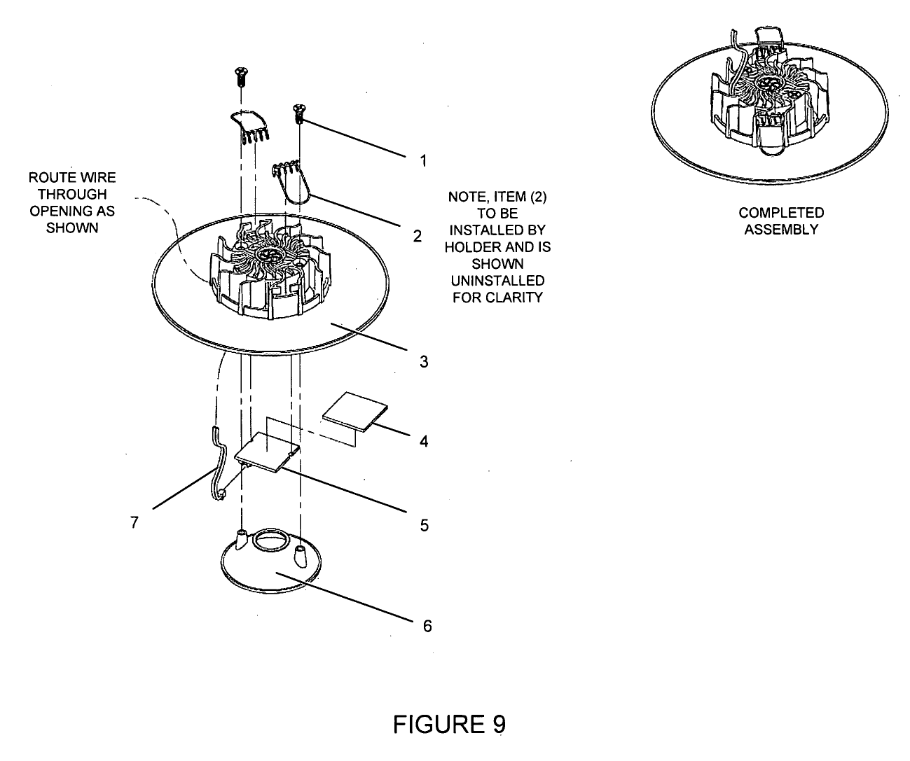

The fixture can be mounted on a wall, ceiling, or other surface. In one exemplary embodiment, as shown in FIGS. 1-4 and FIG. 8, the fixture may be surface-mounted. In another embodiment, as shown in FIG. 9, the fixture may be recessed. In the latter configuration, the ring may be replaced by a flange 40, and may be fastened to the wall, ceiling, or other surface by screws, clips, bolts, snaps, spring clips 42 or similar fastening means.

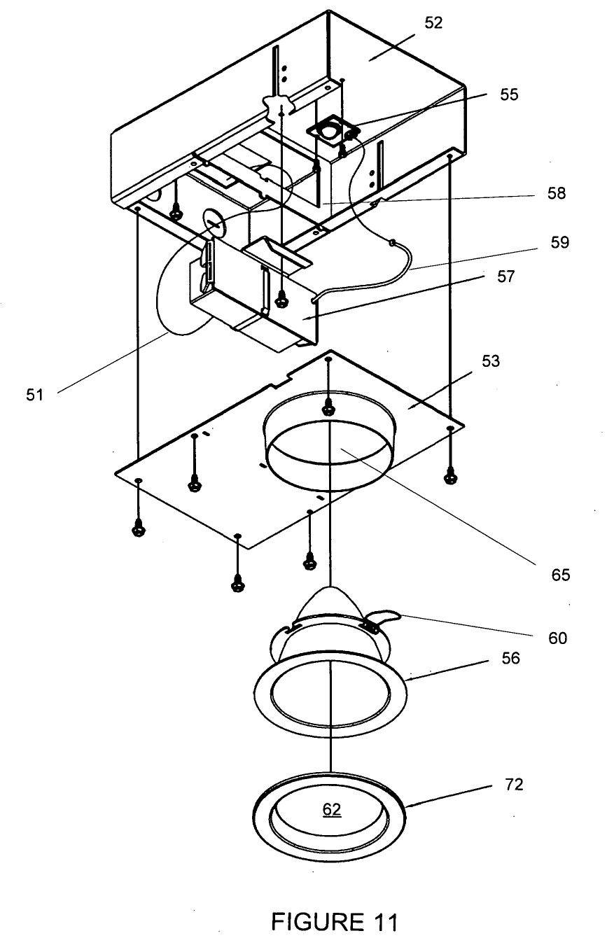

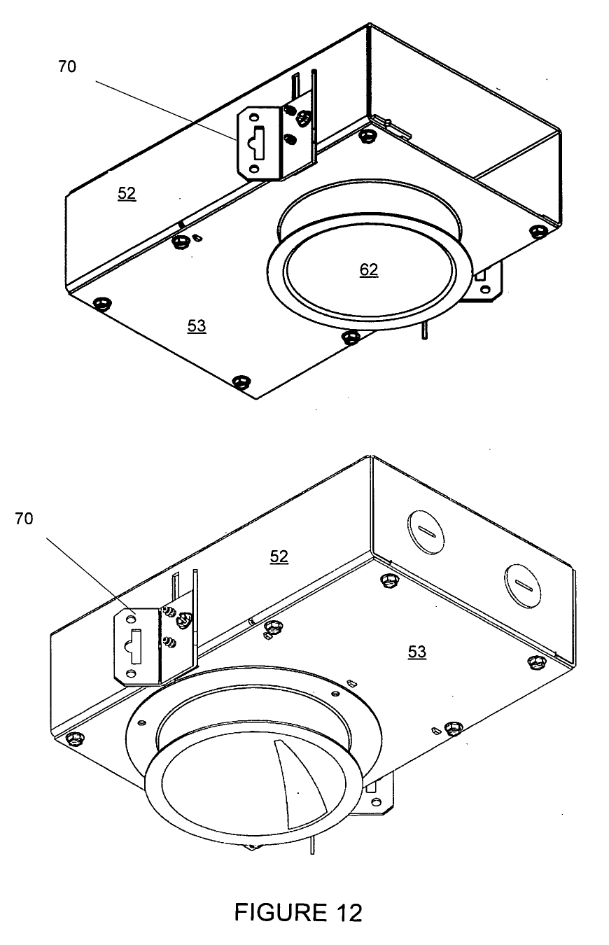

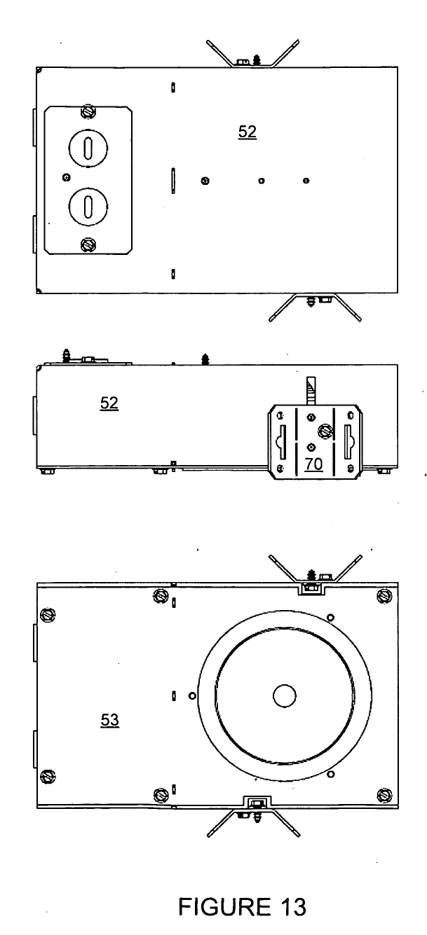

FIGS. 11 through 13 show yet another embodiment of the fixture in a recessed configuration. The heat sink or housing 52 is box-shaped, with a removably-attached bottom 53 and at least one open end. The bottom 53 may be attached to the heat-sink housing 52 in a variety of ways known in the art, including but not limited to screws (as shown), bolts, clips, a sliding engagement, or the like. The heat sink/housing 52 may be formed in a variety of ways and be constructed in a single piece as shown, including but not limited to stamping, die casting, extrusion, or similar techniques. As seen in FIG. 11, the heat sink/housing 52 may be constructed in a single piece as shown to ensure minimal interface points, and thus more efficient heat transfer. The recessed heat sink/housing 52 draws heat from the LED or light source out to the ambient air, thereby allowing for a very shall profile of the luminaire. This design uses less space in the ceiling or space where mounted, costs less to assemble, and uses less material overall than design currently known in the art.

The heat/sink housing may be constructed of a variety of heat-conductive metals or materials, including but not limited to aluminum. The bottom may be constructed of the same or similar metal or material.

Embodiments where the entire housing acts as the heat sink possess distinct advantages. These embodiments do not require additional mounting frames, heat sinks, or additional electrical boxes which may contain the driver, thereby reducing the total number of parts, amount of labor, and overall cost of the luminaire or lighting fixture.

The LED or LED board 55 is attached to the inside of the heat sink/housing 52 by thermal transfer tape or similar attachment means, such as clips and thermal transfer paste. The thermal transfer tape may comprise an expanded aluminum material that uses a titanium boride embedded acrylic adhesive to achieve a precise thermal connection. In one embodiment, the LED board is a high power LED board available commercially, such as the GE Lumination Vio High Power White LED. When properly attached, heat from the LED is transferred away from the LED board out through the housing and sides, including the bottom.

The power supply/electronics module 57 controlling the LED 55 and containing the driver or providing power may be mounted inside the heat sink/housing 52. This reduces the need for a separate junction box, as is required by current fixture designs. In one exemplary embodiment, a cross-piece 58 with a cut-out may extend from one side of the housing to the other to provide a frame to support the power supply/electronics module 57 as shown in FIG. 11. For quick and easy assembly, the electronics module in this embodiment is inserted into the cut-out until clips on the side of the module are engaged. The module may be serviced through the opening 65 in the bottom, such that the module can be serviced even if the fixture has been permanently fixed into place, such as being dry walled in place. One or more power connectors 59, such as a Molex brand connector, extends from the module to the LED 55. One or more wires 51, which may be light gauge, flexible wires, connect the module to an outside driver or power supply.

The bottom 53 has a circular opening 65 designed to receive and hold the reflector assembly 56. The reflector assembly 56 may be mounted in a variety of ways known in the art, including but not limited to spring clips 60 which pull the reflector assembly 56 up and to the LED board. The LED fits within an opening in the top of the reflector assembly 56 so that light can pass through the assembly. In one embodiment, the junction allows for precise optics and has passed UL 1598 testing requirements for WET LOCATION, COVERED CEILING without the use of additional lenses, thereby reducing the cost of the fixture and avoiding problems associated with lens. The light from the LED or light source is controlled by reflectors that are modular, and may be interchangeable to control beam characteristics. Various beam spreads and optical characteristics can be created with different reflectors. The reflector assembly can be used with and without a lens 62 (or multiple lenses) for optical control, aesthetic treatments, environmental applications, or other effects. The lens 62 may be colored, multi-colored, patterned, or shaped in a variety of ways known in the art.

In one exemplary embodiment, the recessed lighting fixture shown in FIGS. 11-13 is approximately 8 5/16 inches long, 5 5/16 inches wide (not including the attachment brackets 70, which may increase the width to 6⅝ inches), and 3½ inches in height (including the extension of the reflector assembly). The aperture of the reflector assembly is approximately 3¼ inches in diameter, with an outer flange 72 diameter of 4 inches. In this embodiment, the power is supplied by an integral Class2 120 volt, 500 mA, AC to DC, constant current driver. The deep cone reflector creates an optimal balance of visual cut off and smooth light output. Mounting may be accomplished by 26-inch hangers and mounting brackets, and can accommodate T-grid ceilings and wood or metal joist ceilings.

LEDs are very sensitive to heat, and overheating reduces light and life of the LED exponentially. The fixture of the present invention controls the light from the LED with reflectors, lens, or similar devices, with enhanced thermal management utilizing both conductive heat transfer and cooling air movement.

The method of assembly of the fixture also is economical and efficient. Domestically-produced LED chips need not be shipped overseas for assembly of the fixture itself. Partial assembly can be performed overseas in order to take advantage of lower labor costs. The final assembly process for the present invention thus can be accomplished quickly and easily, using LEDs of various color temperature and power, and may be done when the final product is ordered (thereby reducing finished goods inventory). This avoids the shipping of the most expensive component twice, and the payment of high duties on re-entry into the United States. The present invention comprises a relatively small number of parts compared to other light fixtures, allowing the fixture to be economically assembled in the United States.

By way of comparison, a similar halogen product has a lamp that runs at 500 degrees C., has an expected life of 2000 hours, and has up to 20 parts. It is commonly made of plastic, and degrades quickly due to the intense heat, and will burn anything it touches. In one embodiment, the present invention runs at 58 degrees C., and has fewer than half the number of parts. The simple construction with less than 10 parts allows fast assembly, and lowers construction and inventory costs.

Thus, it should be understood that the embodiments and examples described herein have been chosen and described in order to best illustrate the principles of the invention and its practical applications to thereby enable one of ordinary skill in the art to best utilize the invention in various embodiments and with various modifications as are suited for particular uses contemplated. Even though specific embodiments of this invention have been described, they are not to be taken as exhaustive. There are several variations that will be apparent to those skilled in the art.

I claim:

1. A light fixture, comprising:
a housing;
an LED attached in a thermally-conductive manner to the housing; and
a reflector assembly attached to the housing.

2. The light fixture of claim 1, wherein the housing is a box shape, comprising a top, first and second opposing sides, and one closed end.

3. The light fixture of claim 2, further comprising a bottom removably attached to the housing, the bottom comprising an opening adapted to receive the reflector assembly.

4. The light fixture of claim 1, wherein the LED is attached to the inside of the housing.

5. The light fixture of claim 1, wherein the LED is attached to the housing with thermal transfer tape.

6. The light fixture of claim 1, further comprising a power supply module, electrically connected to the LED.

7. The light fixture of claim 6, wherein the power supply module is located inside the housing.

8. The light fixture of claim 1, further comprising a heat sink attached to the housing.

9. The light fixture of claim 1, wherein the housing acts as a heat sink.

10. The light fixture of claim 1, wherein the housing comprises one or more fins.

11. The light fixture of claim 10, wherein the fins are curved and radiate from the center of the housing.

12. The light fixture of claim 1, wherein the housing comprises one or more openings to promote air flow through the fixture.

13. The light fixture of claim 1, wherein the housing is circular.

14. The light fixture of claim 1, wherein the housing is adapted to fit inside a wall opening.

15. The light fixture of claim 14, wherein the housing acts as a heat sink to draw heat from the LED to ambient air.

16. The light fixture of claim 14, wherein the light fixture has a shallow profile.

17. The light fixture of claim 1, wherein the reflector assembly is modular and may be changed to control LED beam characteristics.

18. The light fixture of claim 17, further comprising at least one lens.

19. The light fixture of claim 18, wherein the lens is adapted to create aesthetic effects.
